(19) United States
(12) Patent Application Publication
(10) Pub. No.: US 2007/0077824 A1
(43) Pub. Date: Apr. 5, 2007

(54) Connector assembly

(76) Inventors: Dustin Brown, Coppell, TX (US); Bryan Hynecek, Plano, TX (US); Sudong Cho, Plano, TX (US)

Correspondence Address: SCHEEF & STONE, L.L.P., 5956 SHERRY LANE, SUITE 1400, DALLAS, TX, 75225, US

(21) Appl. No.: 11/197,001

(22) Filed: Aug. 4, 2005

(51) Int. Cl. H01R 24/04

(52) U.S. Cl. 439/668

(57) ABSTRACT

A connector assembly for use with a cable or other device in order to make connections that are easily made and unmade. The connector has a body having a distal end at which is disposed a conductor assembly that will be used to make an electrical or other type of connection with a corresponding device. The body also has a proximal end for receiving the cable or other device that is being connected. This cable or other device connects to the conductor assembly within the connector body. The connector body forms a usually circular proximal flange at or near the point at which the cable or other device meets the connector. Adjacent the proximal flange is a portion of reduced dimensions that extends longitudinally toward the distal end and terminating at a main body portion of larger dimensions. The reduced-dimension portion forms an ideal area for gripping the connector in a manner that connections may easily be made and unmade even when the user performing this operation is unable to see the connector.

### CROSS-REFERENCE TO RELATED APPLICATIONS

This application is related to U.S. patent application Ser. No. 11/133,998 entitled “ELECTRICAL CONNECTOR”, which is incorporated herein by reference and in its entirety.

### FIELD OF THE INVENTION

The present invention is directed generally to the field of electrical and optical connectors, and is directed more specifically to a design for a connector assembly for use with applications requiring convenience and reliability in connecting and disconnecting. Connectors according to the present invention may, for example, be used for the electrical cables connecting the various audio and video components of a home entertainment system.

### BACKGROUND

Electrical connectors are used in a wide variety of applications including, frequently, at the terminus of the electrical cables that are used to connect separate pieces of equipment. Applications using such cables may range from heavy-duty industrial applications, to telecommunications, to home electronics. As one example, many consumer-oriented electronics systems are component systems rather than integrated systems. In other words, instead of having all portions of a particular electrical system in one physical unit, where the internal components would be connected by internal wiring, it is very common to have each of the components manufactured as a separate individual physical device that can be purchased separately and then connected together by the consumer.

Especially in consumer-oriented applications, it is often desirable to use connectors capable of being easily installed and removed. For obvious reasons, many consumers elect to perform his function themselves, and wish to be able to do so without tools or extraordinary effort. System-configuration changes may also be done frequently as new components are acquired or old ones rearranged or moved to a different location entirely. When this occurs, connections between components are undone so that the various components can be moved and then the connections remade. Often, the components are connected together by cables that can be used to communicate audio, video, and control information. In some instances electrical power is also transmitted, although the power for each of the devices in the system may also be delivered though a standard power connection to a nearby electrical outlet or power strip.

The connections between components are generally made by cables, each cable containing one or more wires. Optical cables may also be found in a few more modern systems. In order to facilitate connecting a number of devices that are frequently made by different manufacturers, the connectors at which the cables terminate are standardized. There are several different types and sizes of standard connectors, with those having different functions tending to be somewhat different in design. When a cable is used to make a connection between two system components, of course, the component itself will have a corresponding connection point. Cables may also be connected with each other or at hubs where a number of similar devices may be connected.

Connectors used in applications such as home entertainment systems tend to be either male or female, although this is not necessarily the case. Generally speaking, so-called ‘male’ connectors use a probe jack, pin or pins, or combination of leads that are received into plugs or receptacles on corresponding ‘female’ connectors. Although not typical, some connectors may have both pins and receptacles disposed side by side with each other. In some instances the connectors will be secured together using threaded connections, locking pins, or similar fastening means, while in others they simply slide into communication and remain that way until a disconnecting force is applied. In this latter instance corresponding parts are built to relatively close tolerances to make accidental separation less likely. In many cases, the pins or probes carry positive or control signals. Return or ground electrical connections are often made by contacting portions of the connector bodies, such as sleeves or cylinders that correspond when the connection is made. These features are all exemplary, however, and the details of each configuration may vary. Nevertheless, a standard connector of one particular type, in this case the so-called RCA-type connector, may be satisfactorily used as an example in order to provide a background for the present invention.

FIG. 1 is an illustration of a typical RCA connector probe jack 10 as viewed from the side. This type of connector is electrical and often used, for example, at the termination of cables connecting together two components in a home entertainment system, such as a DVD player and an amplifier. Connector 10 is a jack, and is intended for completing a connection with a corresponding plug (not shown) that has a receptacle for receiving probe 17. In this example, probe 17 forms one-half of conductor assembly 15, with sleeve 16 forming the other component. As alluded to above, when connector 10 is connected with a corresponding connector and probe 10 is received into a receptacle centrally formed in a cylinder of the plug connector, then sleeve 16 contacts the conductive outside of the cylinder to form the ground connection. Both sleeve 16 and probe 17 are themselves connected to conductors (not shown) present in cable 19. Although not visible in FIG. 1, inside connector body 12 these internal cable conductors are exposed so that the connection can be securely made with sleeve 16 and probe 17.

The connector 10 is illustrated from the side in FIG. 1, but in this example it is roughly cylindrical in shape and symmetrical; the view from any side would be identical to the view of FIG. 1. This is not necessarily the case, however, and connectors with square, oval, or asymmetrically-flattened cross sections are also known. The body 12 of the connector 10 forms an opening at the center of its cross section, which opening extends though body 12 from its proximal end 13 to its distal end 14. As should be apparent, cable 19 enters the opening formed in body 12 at proximal end 13 and continues until it has been connected with the conductor assembly 15. An analogous arrangement is used for connecting a cable (or the internal wiring of a system component) with the conductor assembly of an RCA-type plug (not shown).

As mentioned above, the connections that utilize connectors such as connector 10 of FIG. 1 are often made and unmade frequently by consumers who neither have nor want to acquire extensive tooling to help with the process. This may occur, for example, in the application of consumer electronics. Home entertainment systems may include numerous components including receivers, amplifiers, monitors, speakers, and so forth. Consumers tend to install such components in entertainment centers or shelving units. The separate components making up these systems are frequently connected by cables outfitted with connectors such as connector 10 shown in FIG. 1. For aesthetic reasons, however, the various connection points are not visible, but rather hidden in the back of the system components.

Frequently, the user (consumer) connecting these systems components will first place them in a shelf or other unit, and then attempt to make the required connections. Often, this will involve having to grasp the connectors from a variety of vantage points, some of which are less than optimum. For example, many connections occur at the back of system components that are situated in shelving systems but that are difficult to move while connected or being connected. Simply pulling the connector out by grasping the cable itself is not recommended. Naturally, a cable connector designed to be easier to grasp and manipulate from a variety of angles and with little leverage would be of great assistance in such circumstances. The connector assembly of the present invention provides just such a solution.

### SUMMARY OF THE INVENTION

The present invention is directed to an improved electrical connector for use, for example, on the ends of audio visual cables. The connectors are advantageously employed to improve the interconnection between various electrical devices. These devices may be system components, other cables, or simply hubs for connecting two or more cables together.

In one aspect, the present invention is a connector assembly for use, for example, at the termination of a cable for transmitting power or electrical or optical signals between components of a home electronics system. The connector assembly includes a body and a conductor assembly protruding from the distal end of the body. The proximal end of the body forms an axial opening for receiving an electrical cable, the cable having one or more wires that are to be connected to the conductor assembly within the body. The proximal end of the body also includes a proximal flange adjacent to a recess formed by a reduced-dimension portion of the body. The recess extends distally until it terminates at a main body portion that includes a barrel and that may include a ring about a portion of its periphery.

In another aspect, the present invention is a connector having a conductor assembly and a body that includes a bushing, a barrel, and may include a ring. The bushing, located at the proximal end of the connector, includes a proximal flange portion, a recessed portion, and a distal flange. The distal flange and the proximal flange of the bushing define the ends of the recessed portion, which therefore provides an advantageous gripping surface for a user. To enhance the user's ability to manipulate the connector, ribs may be formed in the recessed portion or on the surfaces of the distal and proximal bushing flanges that face the recessed portion. Instead of ribs, grooves may also be employed, or a combination of both.

In another aspect, the present invention is a body for a connector including a main body portion having a distal end for receiving a conductor assembly and a proximal end. The proximal end of the main body is adjacent to a reduced-dimension portion terminated at a proximal flange. The reduced dimension portion may include one or more contour features. The contour features may be, for example, ribs or grooves. The body may also include a ring extending outwardly from the main body. The ring may be used for identifying the connector body from others of similar appearance. In an alternate implementation, the ring for this purpose is removable and interchangeable with other identifying rings, pursuant for a desired scheme. For instance, the rings are color-coded according to selected color-coding scheme.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

For a more complete understanding of the present invention, and the advantages thereof, references made to the following drawings in the detailed description below:

FIG. 1 is an illustration of a typical RCA connector probe jack as viewed from the side.

FIG. 2 is a perspective view of a connector assembly according to an embodiment of the present invention.

FIGS. 3a-3c illustrate the barrel of the electrical connector of FIG. 2: FIG. 3a is a perspective view, FIG. 3b is a side view, and FIG. 3c is a sectional views from section line A-A shown in FIG. 3b.

FIGS. 4a-4c illustrate the sleeve of the electrical connector of FIG. 2: FIG. 4a is a side view, FIG. 4b is a sectional view from section line A-A shown in FIG. 4a, and FIG. 4c is a sectional view from section line D-D shown in FIG. 4a.

FIGS. 5a-5c illustrate the ring of the electrical connector of FIG. 2: FIG. 5a is an end view, FIG. 5b is a side view, and FIG. 5c is a perspective view.

FIGS. 6a-6d illustrate the bushing of the electrical connector of FIG. 2: FIG. 6a is a side view, FIG. 6c is a sectional view from section line A-A shown in FIG. 6a, FIG. 6b is a sectional view from section line C-C shown in FIG. 6a, and FIG. 6d is a perspective view.

FIG. 7 is a perspective view of an electrical connector according to another embodiment of the present invention.

FIGS. 8a-8c illustrate the barrel of the electrical connector of FIG. 7: FIG. 8a is a side view, FIG. 8b is a sectional view from section line B-B shown in FIG. 8a, and FIG. 8c is a perspective view.

FIGS. 9a-9c illustrate the ground conductor of FIG. 7: FIG. 9a is a side view, FIG. 9b is a sectional view from section line B-B shown in FIG. 9a, and FIG. 9c is a perspective view.

### DETAILED DESCRIPTION

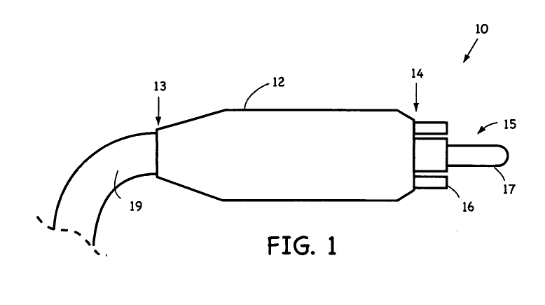

FIGS. 1 through 9, discussed herein, and the various embodiments used to describe the present invention are by way of illustration only, and should not by construed to limit the scope of the invention. Those skilled in the art will understand the principles of the present invention may be implemented in any suitable connectors, in addition to the devices specifically discussed herein.

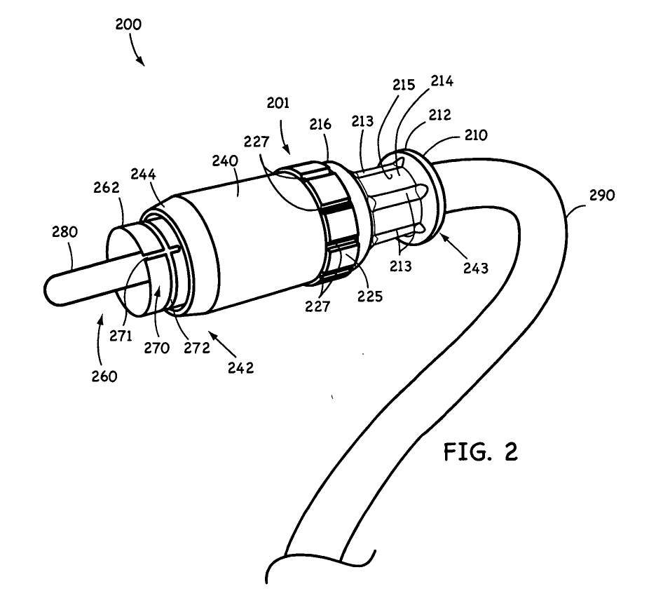

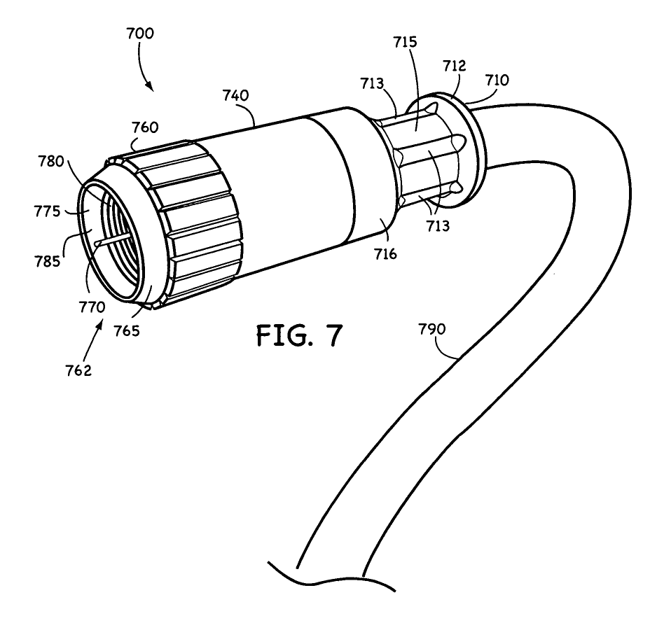

The present invention is directed to a connector, and specifically a connector assembly for use in applications in which connections are expected to be made and broken (that is, connected and disconnected) easily and repeatedly. Making these connections should be as convenient as possible for the consumer, who may sometimes have to grasp the connector in an indirect or awkward fashion. The manner in which the present invention addresses this issue, while at the same time providing a connector aesthetically-pleasing in appearance, will now be explained in reference to two preferred embodiments, typified in FIGS. 2 and 7. Note that while these are in fact electrical connectors, the connector configuration of the present invention may be used in other contexts as well, such as for optical cable connectors. Embodiments other than those shown here exist, as do additional advantages attributable to this novel connector configuration.

FIG. 2 is a perspective view of a connector assembly 200 according to an embodiment of the present invention. As with the connector 10 of FIG. 1, connector 200 is an RCA-type connector. As such, connector 200 is intended for the purpose of connecting cable 290 to another device, which might be for example a component in a home entertainment system. The device to which it might connect is not shown, but it would have an appropriate conductor assembly for making the connection. Connector 200 includes conductor assembly 260 for this purpose. That is, conductor assembly 260 provides the means for establishing an electrical connection with a second device (not shown). This embodiment also provides structural support for the connection as well; the components of conductor assembly 260 maintain, by their construction, the two connecting devices in communication with each other. The component parts of conductor assembly 260 includes a probe 280 and a sleeve 262 for making the two separate electrical connections required of this type of connector.

In this particular case, sleeve 262 employs a C-clip design. The advantages of this design are more comprehensively set forth in U.S. patent application Ser. No. 11/133,998, entitled “ELECTRICAL CONNECTOR”, and filed on May 20, 2005, which is incorporated here in its entirety by reference. For this reason, sleeve 262 forms a first slot 270 having a longitudinal portion 271 and a latitudinal portion 272, the latter extending just over one-half way around the periphery of sleeve 262. The advantages of the C-clip design, which in some ways compliment those of the present invention, are also set forth in the related Patent Application cited and incorporated above.

The body 201 of connector 200 can be said to have a distal end 242 and a proximate end 243. These labels denote reference locations and do not coincide with any specific features unless explicitly stated. In a preferred embodiment, the body 201 comprises a number of different components, as discussed below, but may in some instances be integrally-formed as well. By the same token, any of the components discussed herein as making up the connector body need not necessarily be formed separately from all of the others. For this reason, the terms ‘connector assembly’ and ‘conductor assembly’, as used herein, do not indicate a specific number of parts. In general, however, a connector assembly will include a body and a conductor assembly having at least one conductor. The term conductor will be deemed to include the components necessary to connect optical devices as well as electrical devices. In some embodiments, the conductor assembly could even simply be the termination of an electrical or optical cable.

Typically, however, the cable 290 will be a separate component that connects within body 201 to the conductor assembly 260. Body 201 will therefore almost invariably form an interior chamber (not shown in FIG. 2) for this purpose. Means are employed to make sure the conductor 260 assembly is secured to the body 201 so that the two do not separate from each other in normal connecting and disconnecting. The body serves as a place for the user to grip the connector so that they do not need to grasp the conductor assembly 260 or the cable 290 during this operation.

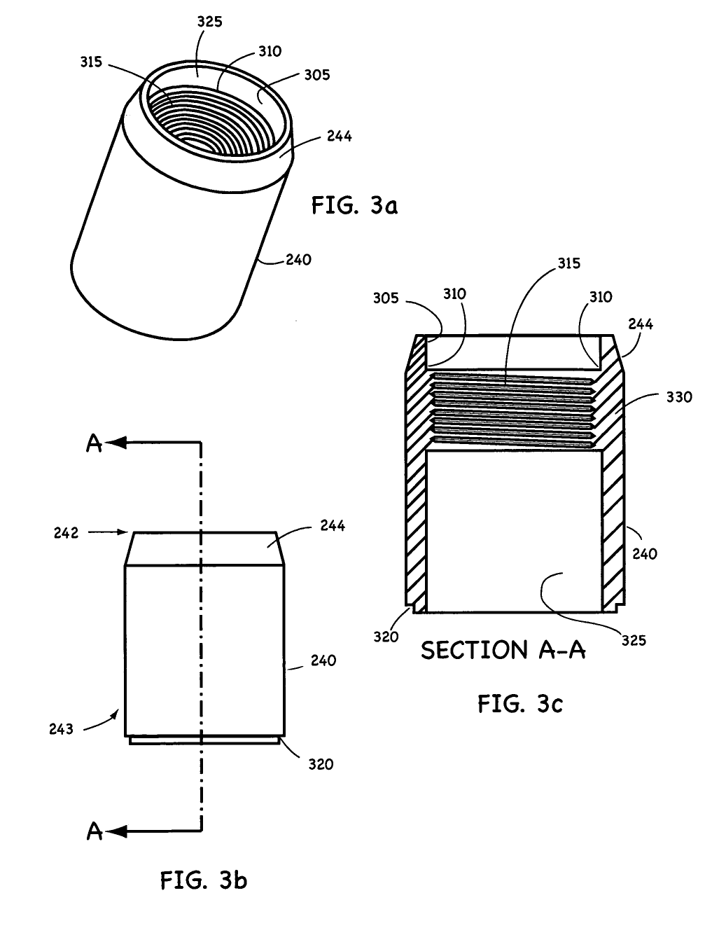

In the embodiment of FIG. 2, the conductor to cable connecting process is located largely within the barrel 240 of connector 200. The barrel 240 is a cylindrical structure having a configuration shown in more detail in FIG. 3. Conductor assembly 260 is received into and secured within barrel 240. Barrel 240 forms a beveled portion 244 on its distal end, which not only contributes aesthetically, but also serves to avoid a sharp shelf-like edge that may be undesirable for a consumer handling or manipulating the connector 200.

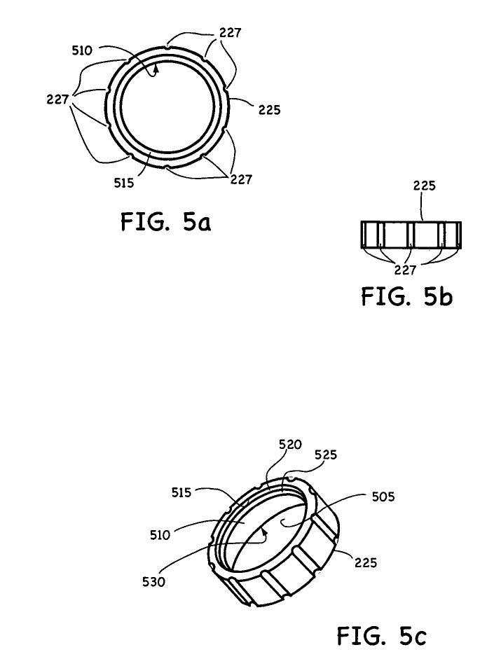

A circumferential ring 225 is disposed at the distal end of barrel 240. In this embodiment, the ring forms a series of equally spaced-apart grooves 227. The ring 225 itself is of an outside diameter greater than that of barrel 240, and the grooves 227 are formed to extend substantially to the barrel diameter. Ring 225 forms a convenient and sure gripping surface for use when the connector 200 is being manipulated. Ring 225 may be used for color coding, that is, colored differently from the rest of the connector 200 or at least differently from other connectors that may be used in the same system. In one implementation the ring 225 is formed as a separate component; in another implementation, ring is part of an integral formation. In a further implementation, when the ring is formed as a separate component, the various colors employed may be selected and interchanged by the consumer. The details of ring 225 are shown in isolation in FIGS. 5a through 5c.

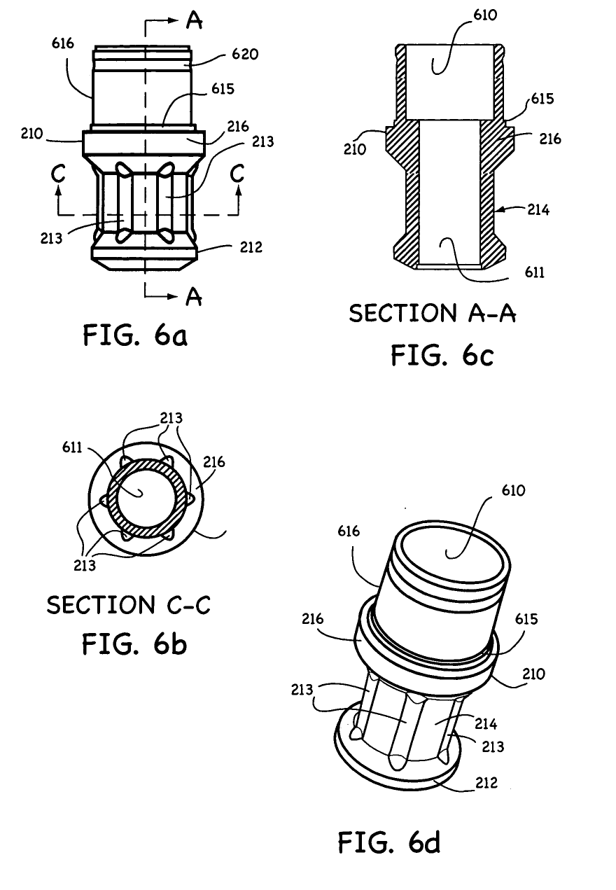

At the distal end 243 of the connector 200 is bushing 210. Bushing 210 forms an opening at its proximal end (not shown in FIG. 2) through which cable 290 enters the connector 200 and proceeds to the interior of barrel 240. The connection to conductor assembly 260 could be made, or partially made, within the bushing 210 itself. Bushing 210 includes means (not shown) for connecting securely with either barrel 240 or conductor assembly 260, or both. The details of bushing 210 of the embodiment of FIG. 2 may be viewed in FIGS. 6a though 6d.

As can be seen in FIG. 2, bushing 210 forms a distal collar 216 and a proximal collar 212, separated by a reduced-diameter portion 215. Reduced-diameter portion 215 provides a recessed wall 214 that functions as an advantageous area for gripping by a consumer who is connecting or disconnecting the cable 290 from another device. As alluded to above, this is often done when the connector is located at a relatively difficult-to-access location, such as the back side of a system component that is stored in a cabinet. With standard connectors, such as the one illustrated in FIG. 1, there is a tendency to pull the connector out by grasping the cable, which may loosen or break the connections made between the cable and the conducting assembly inside the body. This tendency is largely frustrated by the presence of proximal flange 212. To increase the manipulative control afforded to the user, one, or preferably several ribs 213 are formed on recessed wall 214.

These ribs 213 formed on recessed wall 214 are preferably spaced-apart about the periphery of recessed wall 214, and occur at intervals intended to provide contact with one or two of each of the user's fingers as they contact the area. The ribs 213 shown in FIG. 2 are longitudinal, meaning they extend in a direction parallel to a central axis passing through the center of the distal and proximal ends of connector 200. In another embodiment (not shown) the ribs could be formed to extend all or part of the way around the periphery of recessed wall 214. Such latitudinal ribs (one or more) could be present together with or in lieu of longitudinal ribs 213. In yet another embodiment, grooves (not shown) are formed in recessed wall 214 along with or instead of ribs 213. Note that in the embodiment of FIG. 2, the ribs 213 continue part of the way onto both proximal flange 212 and distal flange 216, although this particular construction is optional.

FIGS. 3a-3c illustrate the barrel 240 of the electrical connector 200 of FIG. 2: FIG. 3a is a perspective view, FIG. 3b is a side view, and FIG. 3c is a sectional views from section line A-A shown in FIG. 3b. Barrel 240 includes side wall 330 that is generally in the shape of a cylinder and forms recess 325, which extends all of the way through the barrel 240 from its proximal end to its distal end. On its exterior, wall 330 forms beveled portion 244, which is visible also in FIG. 2, and annular channel 320, which is not. Annular channel 320 is formed to ensure the proper seating of ring 225 shown in FIGS. 2 and 5a through 5c. Barrel 240 includes an interior threaded portion 315 that is used to secure the sleeve 262. When installed, sleeve 262 is seated on annular shelf 310 and lies adjacent to interior face 305. The assembly of the various components of connector assembly 200 is discussed further below.

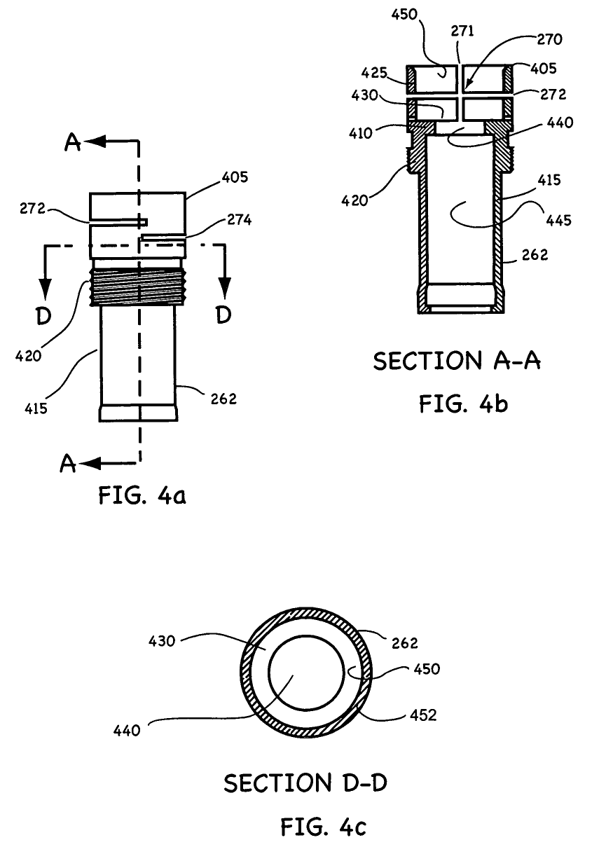

FIGS. 4a-4c illustrate the sleeve 262 of the electrical connector of FIG. 2: FIG. 4a is a side view, FIG. 4b is a sectional view from section line A-A shown in FIG. 4a, and FIG. 4c is a sectional view from section line D-D shown in FIG. 4a. Sleeve 262 includes a distal portion 405 that includes an outer wall 425 that is generally in the shape of a cylinder. In use sleeve 262 corresponds with an appropriate conductor by receiving it into recess 450 formed in part by outer wall 452. The corresponding conductor, when received, is disposed adjacently to floor 430 at the proximal termination of recess 450. The opening 440 formed in throat wall 410 is for permitting the jack 280 (shown in FIG. 2) to pass. When installed, jack 280 is separated from the throat wall 410 by an insulating dielectric material (not shown).

In order to facilitate the reception of a corresponding conductor (not shown) into recess 450, the outer wall 425 of distal portion 405 forms utilizes a C-clip configuration. Further details of this innovation are set forth in U.S. patent application Ser. No. 11/133,998, filed on May 20, 2005, which has been incorporated herein by reference. In general, slot 270 includes first portion 271 that extends parallel to the longitudinal axis of the connector 200, and a second portion that extends along the periphery of outer wall 425 for just over one-half of its circumference. Slot 270, shown almost entirely in FIG. 4b, is also visible in FIG. 2. The second portion 274 of a second slot (not otherwise visible) is shown in FIG. 4a. The configuration of this second slot in similar to that of slot 270, except that its second portion 274 is formed proximal of second portion 272 of slot 270.

Sleeve 262 also includes (an external) threaded portion 420 for corresponding with the (internal) threaded portion 315 of barrel 240 so that the two components of connector 200 are in this manner secured together when the connector is assembled. Threaded portion 420 is formed on an extended shield portion 415 of sleeve 262. In use, connector 200 receives a cable (for example cable 290 shown in FIG. 2) into recess 445 formed by shield portion 415. The use of an extended shield portion such as shield portion 415 in connector assembly 200 has been found to improve its performance as an electrical connector. Within recess 445 the connections between the conductor assembly 260 and cable 290 are made, including the attachment to probe jack 280. Note again, however, that the cable and conductor assembly are not a requirement unless explicitly recited. In addition, other types of conductor assemblies may be used with the connector assembly of the present invention.

FIGS. 5a-5c illustrate the ring 225 of the electrical connector of FIG. 2: FIG. 5a is an end view, FIG. 5b is a side view, and FIG. 5c is a perspective view. Ring 225 includes a plurality of grooves 227, which not only contribute to the appearance of ring 225, but also provide a convenient gripping surface when assembled with the remaining components of connector assembly 200. When assembled, the connector assembly 200 is received within opening 5OS formed by inner surface 510 of ring 225. Protusion 515 of ring 525 corresponds with annular channel 320 of barrel 240 to ensure a proper fit between the two components and to fix ring 525 in the longitudinal direction. A second annular channel 520 is present on ring 525 for the same reason, except that it mates with annular protrusion 615 (shown, in FIG. 6d). That is to say, channel defines an etch formed by two surfaces meeting at an angle, and the protusion 515 is also defined by two surfaces meeting at an angle.

Ring 225 adds contour to the connector 200, enhancing its appearance and at the same time affording a more sure grasp for a user that is connecting or disconnecting the device. In addition, ring 225 may be manufactured in a variety of different colors or other appearance-differentiation characteristics so that it may be used for identifying the connector upon which it is used, and distinguishing it from other connectors with similar appearances. Because connectors such as connector 200 are sometimes used in sets of two or three (or more) that connect in close proximity, using the same identifier at, for example, both ends of a cable can be of great advantage. Many standard connectors are color-coded for this purpose.

FIGS. 6a-6d illustrate the bushing 210 of the electrical connector of FIG. 2: FIG. 6a is a side view, FIG. 6b is a sectional view from section line C-C shown in FIG. 6a, FIG. 6c is a sectional view from section line A-A shown in FIG. 6a, and FIG. 6d is a perspective view. Bushing 210 is, in this embodiment, the most proximal component of connector 200. As such, cable 290, when installed, enters first into proximal recess 611 formed by bushing 210, and then continues into distal recess 610 formed in bushing 210. The process of connecting cable 290 with conductor assembly 260 may or may not begin in bushing 210.

Externally, bushing 210 includes a proximal flange and a distal flange defining either end of a region of reduced dimension. (In this embodiment, the reduced dimension is the diameter of bushing 210, but other cross-sections are possible.) In this embodiment, the reduced-dimension region includes a wall 214 populated with a plurality of raised ribs 213. The ribs 213 are equally spaced apart in this embodiment, but need not be. Any number of ribs may be used. The combination of ribbed interior wall 214 with flanges 212 and 216 have been found to facilitate control by a user attempting to manipulate connector 200.

When assembled, the distal extension 616 of bushing 210 is received into recess 325 of barrel 240 (see FIG. 3c). Ring 225, if present, is disposed exterior to distal extension 216 and mates with annular protrusion 615 and annular recess 320 of barrel 240 as mentioned above. If ring 225 is not present, the dimensions of distal extension 616 of bushing 210 and recess 325 of barrel 240 are adjusted accordingly.

Although the components of connector assembly 200 are typically made of a metallic material, other materials may be used. In particular, bushing 210 or ring 225 may be made of an elastomeric or plastic material where a certain amount of malleability or flexibility may be useful.

FIG. 7 is a perspective view of a connector assembly 700 according to another embodiment of the present invention. Although the similarities to the connector 200 of FIG. 2 should be apparent, connector 700 is what is referred to as an f-type connector. Many of the differences, however, will be manifest in the conductor assembly 762 and in the (in most cases, relatively minor) modifications necessary to accommodate the specific conductor assembly being used. From this it should also be apparent that the connector assembly of the present invention may be used in a variety of applications by substituting the appropriate standard (or non-standard) conductors. In one embodiment (not shown), the connector assembly of the present invention may even be used for terminating an optical cable using an optical conductor assembly, such as for a tos-type connector.

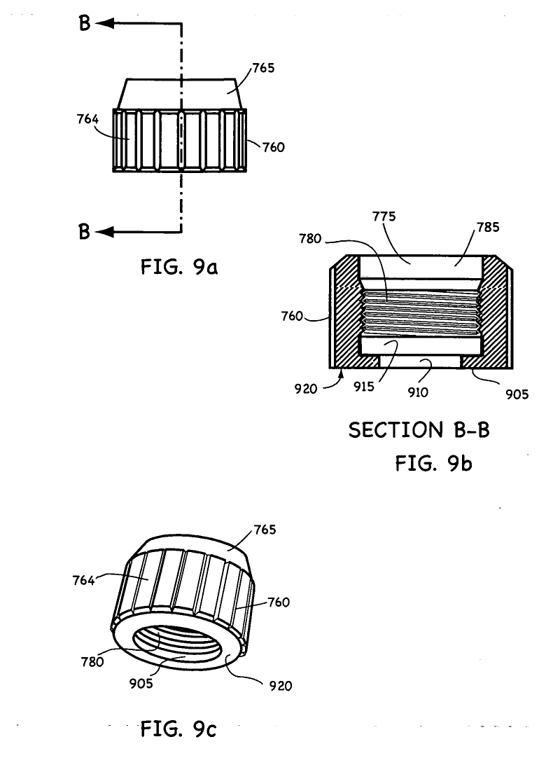

Returning to the embodiment of FIG. 7, the conductor assembly 762 includes a pin 770 and a ground conductor 760. Note that the terms used to describe the conductor assembly 762 are somewhat arbitrary, and the function or presence of its components is not a requirement of the invention unless explicitly recited. For example in other embodiments there may be several pins present, or some other form of conductor may be used instead. The ground conductor of the illustrated embodiment is described in more detail in reference to FIGS. 9a through 9c.

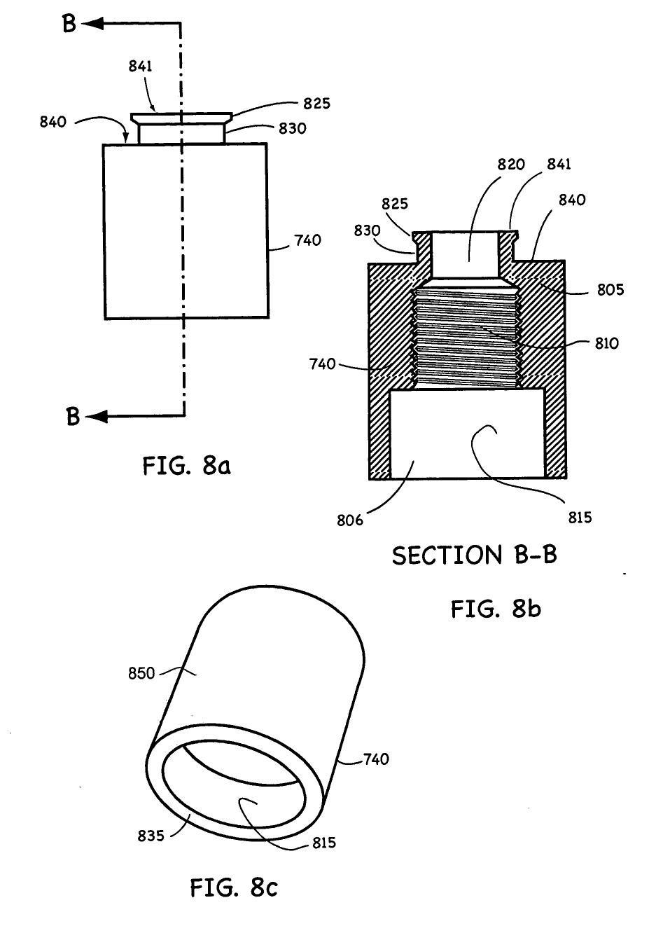

Adjacent to the conductor assembly 762 is the barrel 740, which again serves as a main body for the connector assembly 700 and a housing for the actual connection between the conductors of cable 790 and those of the conductor assembly 762. In this embodiment, the ground conductor 760 may be rotated with respect to the barrel 740 in order to engage the threads 780 with a corresponding threaded portion on the device to which connector 700 is being engaged. The barrel 740 is described in more detail below in reference to FIGS. 8a through 8c.

FIGS. 8a-8c illustrate the barrel 740 of the connector assembly 700 of FIG. 7: FIG. 8a is a side view of barrel 740, FIG. 8b is a sectional view from section line B-B shown in FIG. 8a, and FIG. 8c is a perspective view. Barrel 740 is, generally speaking, a cylinder 805 having an inner wall that forms an internal channel 806. The internal channel 806 a proximal recess 815 into which bushing 710 is received. Bushing 710 is, in this embodiment, similar to bushing 210 and is not separately illustrated. As should be apparent, however, distal flange 716 of bushing 710 is directly adjacent to barrel 740 because no ring (such as ring 225 shown in FIG. 2) is present in this embodiment. Flange 716 will directly contact the proximal surface 835 of barrel wall 805 (See FIG. 8c). For this reason the recess 815 of the distal extension of the bushing it receives (not shown) must be appropriately sized relative to each other. Of course, the embodiment of FIG. 7 could also be modified to accommodate a ring if desired.

Barrel 740 at its distal end is configured to correspond with ground conductor 760. As mentioned above, ground conductor 760 (see also FIGS. 9a through 9c) will rotate relative to barrel 740 to establish a threaded connection with another connecting device. To facilitate this rotation, distal face 840 forms a distal extension 841 that is received into an opening in the ground conductor 760. Distal extension 841 forms an external annular recess 830 and annular protrusion 825 in order to facilitate the rotational movement of the ground conductor. That is to say, extension 841 acts as a facilitator to facilitate attachment of the ground connector 760 while also permitting rotation. The pin 770 is not shown in FIGS. 8a through 8c, but in the assembled configuration it would be part of an assembly (not shown) that is secured in barrel 740 at threaded portion 810 in such a manner that the pin 770, insulated electrically from the ground conductor, protrudes from opening 820 formed within the cylindrically-shaped distal extension 841 of barrel 740.

FIGS. 9a-9c illustrate the ground conductor of FIG. 7: FIG. 9a is a side view, FIG. 9b is a sectional view from section line B-B shown in FIG. 9a, and FIG. 9c is a perspective view. Note that the term ‘ground conductor’ is for convenience, and refers to its role in this particular embodiment. There is no requirement, however, that it actually perform this function unless explicitly recited. In some embodiments (not shown) the ground conductor may in fact perform only a structural function. In the embodiments of FIGS. 9a through 9c, ground conductor 760 includes a beveled distal portion 765 for ease in placing in communication with its corresponding connector (not shown). Grooved periphery 764 facilitates its rotation to engage threads 780, formed on inner wall 775 when another, externally-threaded connector is received into recess 785. At the proximal end of ground conductor 760, throat wall 905 forms a narrow opening 910 through which passes distal extension 841 until annular protrusion 825 is disposed within recess 915 and the proximal face 920 of ground conductor 760 is adjacent to distal face 840 of barrel 740. Narrow opening 910 may be just large enough to allow annular protrusion 825 (of barrel 740) to pass, or it may be slightly too small so that distal extension 841 must be forced into place, but is not removable absent a sufficient force in the opposite direction. In another embodiment, the components may also be formed or completed in an assembled configuration. implementing the invention, and the scope of the invention should not necessarily be limited by this description. Rather, the scope of the present invention is defined by the following claims.

What is claimed is:

1. A connector assembly, comprising:
a conductor assembly; and
a body having a proximal end and a distal end, the body comprising a main body portion and a proximal-end flange separated from the main body by a reduced-dimension portion.

2. The connector assembly of claim 1, wherein the reduced-dimension portion is ribbed.

3. The connector assembly of claim 2, wherein the reduced-dimension portion comprises a plurality of ribs.

4. The connector assembly of claim 1, wherein the plurality of ribs are disposed in an equally-spaced relationship about the reduced-dimension portion.

5. The connector assembly of claim 1, wherein the flange is substantially circular in cross section and is formed about a central axis extending through the proximal end and distal end of the body of the connector assembly.

6. The connector assembly of claim 1, wherein the reduced-dimension portion is grooved.

7. The connector assembly of claim 1, wherein the reduced-dimension portion is substantially circular in cross section and is formed about a central axis extending through the proximal end and distal end of the body of the connector assembly.

8. The connector assembly of claim 1, wherein the connector is an electrical connector.

9. The connector assembly of claim 8, wherein the connector is an RCA-type connector.

10. The connector assembly of claim 8, wherein the connector is an f-type connector.

11. The connector assembly of claim 8, wherein the connector is an s-video-type connector.

12. The connector assembly of claim 1, wherein the connector is an optical connector.

13. The connector assembly of claim 12, wherein the connector is a tos-type connector.

14. The connector assembly of claim 1, further comprising a ring disposed circumferentially about the body.

15. The connector assembly of claim 14, wherein the ring is formed separately from the remainder of the body.

16. The connector assembly of claim 14, wherein the ring is color-coded.

17. The connector assembly of claim 14, wherein the ring forms a plurality of grooves.

18. The connector assembly of claim 14, wherein the ring has an outside diameter exceeding that of the remainder of the connector body.

19. The connector assembly of claim 1, wherein the body comprises a bushing.

20. The connector assembly of claim 19, wherein the bushing is formed separately from the remainder of the body.

21. The connector assembly of claim 19, wherein the flange is formed on the proximal end of the bushing.

22. A body for a connector, said body for housing the electrical connection between a cable and a connector conductor assembly, said connector body comprising:
a main body portion; and
a proximal body portion forming a recess for receiving the cable; and
wherein the proximal body portion forms a region of reduced-dimension defined by a proximal flange and a distal flange.

23. The connector of claim 22, wherein the region of reduced-dimension is populated with a plurality of ribs.

24. The connector of claim 22, wherein the proximal body portion is integrally-formed with the main body portion.

25. The connector of claim 22, further comprising a ring beyond the main body portion.

26. The connector of claim 25, wherein the ring is integrally-formed with the main body portion.
